(19) United States
(12) Patent Application Publication
(10) Pub. No.: US 2007/0080202 A1
(43) Pub. Date: Apr. 12, 2007

(54) Rotatable keypad assembly of portable terminal

(75) Inventors: Jong-Choon Jo, Seoul (KR); Seung-Kyun Heo, Seongnam-si (KR)

Correspondence Address: DILWORTH & BARRESE, LLP, 333 EARLE OVINGTON BLVD., SUITE 702, UNIONDALE, NY, 11553, US

(73) Assignee: Samsung Electronics Co., Ltd., Suwon-si (KR)

(21) Appl. No.: 11/541,750

(22) Filed: Oct. 2, 2006

(30) Foreign Application Priority Data
Oct. 11, 2005 (KR) 10-2005-0095436

(51) Int. Cl. G06C 7/02

(52) U.S. Cl. 235/145 R

(57) ABSTRACT

Provided is a rotatable keypad assembly including a plurality of keybuttons used as a data input unit of a portable terminal. In the rotatable keypad assembly, a roller is rotatably installed at a predetermined position in the portable terminal and has a portion exposed outside the portable terminal. A keypad sheet is wound around the roller and has the keybuttons thereon. A knob is interlocked with one end of the roller and is rotated to expose the keybuttons corresponding to the exposed portion of the roller. Accordingly, it is possible to reduce the size, thickness and weight of the portable terminal without presenting any difficulty in using the portable terminal.

### PRIORITY

This application claims priority under 35 U.S.C. § 119 to an application entitled “Rotatable Keypad Assembly for Portable Terminal” filed in the Korean Intellectual Property Office on Oct. 11, 2005 and assigned Serial No. 2005-95436, the contents of which are incorporated herein by reference.

### BACKGROUND OF THE INVENTION

1. Field of the Invention

The present invention relates generally to a keypad assembly with keybuttons used as a data input unit of a portable terminal, and in particular, to a rotatable keypad assembly of a portable terminal, which can serve to miniaturize the portable terminal.

2. Description of the Related Art

In general, portable terminals essentially have a plurality of keybuttons regardless of their types. The keybuttons can be broadly classified into 3×4 array of alphanumeric keybuttons, function keybuttons, and mode switch keybuttons. The 3×4 array of alphanumeric keybuttons are installed apart from one another by a predetermined distance on the front of the portable terminal and are used as a data input unit for inputting data such as numerals and characters. The function keybuttons and the mode switch buttons are installed at predetermined positions on the portable terminal.

However, the keybuttons as a whole typically occupy a space larger than the half of the portable terminal. Also, each of the keybuttons includes a keypad sheet, a keypad rubber, and a metal dome mounted on the main board of the portable terminal, which increases the thickness of the mobile terminal. Therefore, the arrangement and configuration of the keybuttons are very important in reducing the size, thickness and weight of the portable terminal.

### SUMMARY OF THE INVENTION

An object of the present invention is to substantially solve at least the above problems and/or disadvantages and to provide at least the advantages below. Accordingly, an object of the present invention is to provide a rotatable keypad assembly of a portable terminal, which can reduce the size, thickness and weight of the portable terminal while providing all the conventional keybutton functions.

Another object of the present invention is to provide a rotatable keypad assembly of a portable terminal, which can reduce the size, thickness and weight of the portable terminal and enhance the ease of use of the portable terminal by eliminating a conventional grid-pattern keybutton array arrangement.

According to an aspect of the present invention, a rotatable keypad assembly includes a plurality of keybuttons used as a data input unit of a portable terminal. In the rotatable keypad assembly, a roller is rotatably installed at a predetermined position in the portable terminal and has a portion exposed outside the portable terminal. A keypad sheet is wound around the roller and has the keybuttons. A knob is interlocked with one end of the roller and is rotated to expose and click the keybuttons corresponding to the exposed portion of the roller.

### BRIEF DESCRIPTION OF THE DRAWINGS

The above and other objects, features, and advantages of the present invention will become more apparent from the following detailed description when taken in conjunction with the accompanying drawings in which:

FIG. 1 is a perspective view of a portable terminal with a rotatable keypad assembly according to the present invention; and

FIG. 2 illustrates the configuration of a rotatable keypad assembly according to the present invention.

### DETAILED DESCRIPTION OF THE PREFERRED EMBODIMENTS

Preferred embodiments of the present invention will be described herein below with reference to the accompanying drawings. In the following description, well-known functions or constructions are not described in detail because they would obscure the present invention in unnecessary detail.

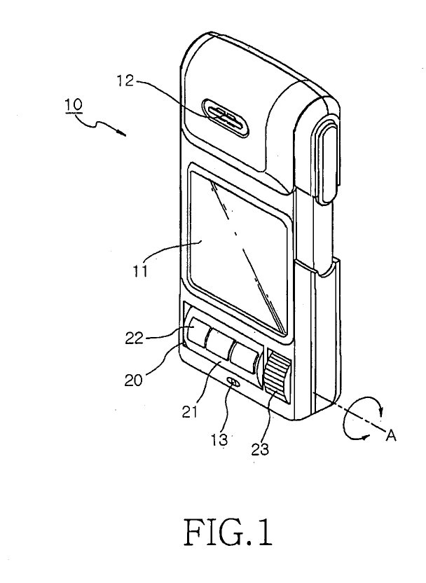

FIG. 1 is a perspective view of a portable terminal with a rotatable keypad assembly according to the present invention. A bar type portable terminal is illustrated in FIG. 1. However, the rotatable keypad assembly according to the present invention can be applied to any type of terminal that uses a plurality of keybuttons as a data input unit. For example, the rotatable keypad assembly can be applied to bar type terminals, folder type terminals, slide type terminals, slide-and-rotation type terminals, and pop-up type terminals. However, the present invention is not limited to such terminals, but can be applied to various types of terminals that require the technical concept of the present invention.

Referring to FIG. 1, a display unit 11 is installed at the front of a portable terminal 10. The display unit 11 is preferably a high-definition color thin film transistor liquid crystal display (TFT LCD) module. A speaker unit 12 is installed at the top of the display unit 11. The speaker unit 12 is a receiver unit for receiving a voice from another party. A rotatable keypad assembly 20 according to the present invention is installed at the bottom of the display unit 11. A microphone unit 13 is installed at the bottom of the keypad assembly 20. The microphone unit 13 is a transmitter unit for transmitting a user's voice to the other party.

The keypad assembly 20 of the present invention is configured to reduce the space required for installing a plurality of conventional keybuttons that are arranged in a grid pattern. A rotatable knob 23 is installed such that it protrudes slightly from the front face of the portable terminal 10. Preferably, a knurl portion is formed on the outer circumference of the rotatable knob 23 such that the user can conveniently rotate the rotatable knob 23. A cylindrical roller 21 is installed next to the rotatable knob 23, and a plurality of keybuttons 22 are attached onto the cylindrical roller 21. Therefore, a user can select a desired one of the keybuttons 22 attached on the cylindrical roller 21, while rotating the rotatable knob 23 around a rotation axis A in a scrolling fashion. Necessary characters and numerals are engraved on the keybuttons 22. Accordingly, the user can input desired data into the portable terminal by pressing or clicking the desired keybuttons 22 that are exposed outside the portable terminal 10 by rotation of the rotatable knob 23. Although the rotatable knob 23 is illustrated as being installed on the front of the portable terminal 10, the present invention is not limited to such a structure. That is, depending on the shape of the portable terminal 10, the rotatable knob 23 may be installed to protrude from the side or rear of the portable terminal 10. In this way, the present invention eliminates the conventional grid-pattern keybutton. Accordingly, it is possible to greatly reduce the size and volume of the portable terminal 10. Alternatively, the display unit 11 can be extended into the installation space of the conventional keybuttons, thereby making it possible to use a high-definition wide LCD in the portable terminal 10.

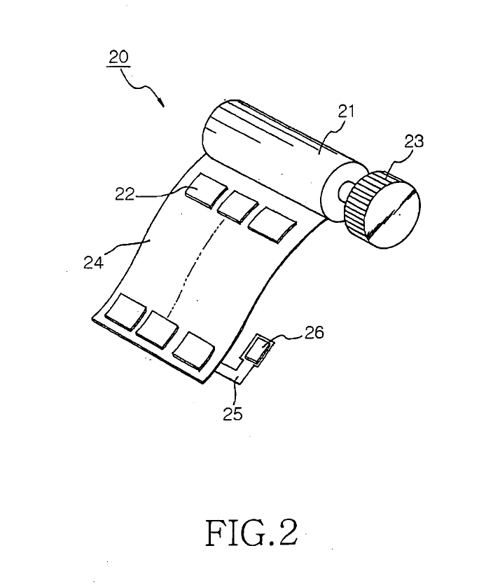

FIG. 2 illustrates the configuration of a rotatable keypad assembly according to the present invention.

Referring to FIG. 2, the keybuttons 22 are arranged on a keypad sheet 24, and the keypad sheet 24 is wound around the cylindrical roller 21. It is preferable that the keypad sheet 24 is wound once around the outer circumference of the cylindrical roller 21. The keypad sheet 24 may be a flexible printed circuit board (FPCB) or may be a flexible silicon rubber sheet with a FPCB attached thereon. Also, carbon contacts may be patterned at positions corresponding to the keybuttons 22 on the FPC board, metal domes for connection may be attached on the top portions of the carbon contacts, and the keybuttons and a keypad rubber are attached on the top portions of the metal domes. The keypad sheet 24 may have the same structure as that of a well-known keypad unit, and may have such flexibility that allows it to be wound around the cylindrical roller 21. Also, the keypad sheet 24 may be fixed to the cylindrical roller 21 by, for example, bonding. In addition, a pattern 25 extends a predetermined length from the FPC board, and a connector 26 is installed at the end of the pattern 25. The connector 26 extends into the portable terminal 10 such that it can be electrically connected to the main board (not illustrated) of the portable terminal 10.

As described above, the rotatable keypad assembly according to the present invention can reduce the size, thickness and weight of the portable terminal without presenting any difficulty in using the portable terminal.

While the present invention has been shown and described with reference to certain preferred embodiments thereof, it will be understood by those skilled in the art that various changes in form and details may be made therein without departing from the spirit and scope of the present invention as defined by the appended claims.

What is claimed is:

1. A rotatable keypad assembly including a plurality of keybuttons used as a data input unit of a portable terminal, the keypad assembly comprising:
a roller rotatably installed at a predetermined position in the portable terminal, the roller having a portion exposed to the outside of the portable terminal;
a keypad sheet wound around the roller, the keypad sheet having the plurality of keybuttons; and
a knob interlocked with one end of the roller, the knob being rotated to expose the keybuttons corresponding to the exposed portion of the roller.

2. The rotatable keypad assembly of claim 1, wherein the rotatable keypad assembly is applied to one of a bar type terminal, a folder type terminal, a slide type terminal, a slide-and-rotation type terminal, and a pop-up type terminal.

3. The rotatable keypad assembly of claim 1, wherein the roller and the knob are formed into one body, and the knob has a knurl portion formed on an outer circumference to facilitate the rotation thereof.

4. The rotatable keypad assembly of claim 3, wherein the rotatable keypad assembly is applied to one of a bar type terminal, a folder type terminal, a slide type terminal, a slide-and-rotation type terminal, and a pop-up type terminal.

5. The rotatable keypad assembly of claim 3, wherein the keypad sheet further includes:
a flexible printed circuit board (FPCB);
a plurality of metal domes attached to a corresponding carbon contact of the FPCB; and
a keypad rubber attached onto the metal domes,
wherein the keypad sheet is electrically connected to a main body of the portable terminal by a connector extending a predetermined distance from the FPCB.

6. The rotatable keypad assembly of claim 5, wherein the rotatable keypad assembly is applied to one of a bar type terminal, a folder type terminal, a slide type terminal, a slide-and-rotation type terminal, and a pop-up type terminal.

7. The rotatable keypad assembly of claim 5, wherein the keypad sheet is wound once around an outer circumference of the roller.

8. The rotatable keypad assembly of claim 7, wherein the rotatable keypad assembly is applied to one of a bar type terminal, a folder type terminal, a slide type terminal, a slide-and-rotation type terminal, and a pop-up type terminal.

9. A portable communication terminal comprising a rotatable keypad assembly for inputting data, the keypad assembly comprising:
a roller rotatably installed at a position in the portable terminal, the roller having a portion exposed to the outside of the portable terminal;
a keypad sheet wound around the roller, the keypad sheet having a plurality of keybuttons; and
a knob interlocked with one end of the roller, the knob being rotated to expose the keybuttons corresponding to the exposed portion of the roller.

10. The portable communication terminal of claim 9, wherein the roller and the knob are formed into one body, and the knob has a knurl portion formed on an outer circumference to facilitate the rotation thereof.

11. The portable communication terminal of claim 10, wherein the keypad sheet further includes:
a flexible printed circuit board (FPCB);
a plurality of metal domes attached to a corresponding carbon contact of the FPCB; and
a keypad rubber attached onto the metal domes,
wherein the keypad sheet is electrically connected to a main body of the portable terminal by a connector extending a distance from the FPCB.

12. The portable communication terminal of claim 11, wherein the keypad sheet is wound once around an outer circumference of the roller.

13. The portable communication terminal of claim 12, wherein the portable communication terminal is one of a bar type terminal, a folder type terminal, a slide type terminal, a slide-and-rotation type terminal and a pop-up type terminal.
